(19) United States
(12) Patent Application Publication
(10) Pub. No.: US 2012/0119583 A1
(43) Pub. Date: May 17, 2012

(54) COMBINED DC POWER SOURCE AND BATTERY POWER CONVERTER

(76) Inventor: Lars P. Allfather, Cambridge, MA (US)

(21) Appl. No.: 12/948,142

(22) Filed: Nov. 17, 2010

(51) Int. Cl. H02J 3/00

(52) U.S. Cl. 307/72

(57) ABSTRACT

Power converter systems and methods that can combine multiple direct-current (DC) power sources with an independent alternating-current (AC) power source coupled across a load, thereby allowing power to be transferred between the DC power sources, the independent AC power source, and/or the load. The power converter systems and methods offer increased versatility and functionality over traditional power converter systems and devices.

### STATEMENT REGARDING FEDERALLY SPONSORED RESEARCH OR DEVELOPMENT

This invention was made under Department of Energy Contract No. DE-FC36-03NT41838. The Federal Government has certain rights to this invention.

### FIELD OF THE INVENTION

The present application relates generally to power conversion systems and methods, and more specifically to power converter systems and methods that allow power to be transferred between multiple direct-current (DC) power sources, an AC power source, and/or a load, thereby achieving increased versatility and functionality.

### BACKGROUND OF THE INVENTION

Bidirectional DC/AC inverters are known that can be used to satisfy power conversion requirements by converting alternating-current (AC) power provided by an AC power source into direct-current (DC) power at a DC output, or by converting DC power provided by a DC power source into AC power at an AC output. Such bidirectional DC/AC inverters typically include power conversion circuitry that can be controlled to perform current and/or voltage regulation, and thereby effect a power flow between the DC power source and the AC output.

Power systems such as uninterruptable power systems are also known that can convert DC power provided by a battery into AC power, and output the AC power to a load when a failure occurs in an AC power source, such as a 50/60 Hz power grid. Such uninterruptable power systems can include one or more inverters for power conversion, and an inverter control circuit for generating pulse width modulation (PWM) control signals, thereby subjecting the respective inverters to PWM control. When an increase in capacity is required, a plurality of such uninterruptible power systems can be connected in parallel to achieve parallel operation of the respective inverters.

In view of the known power conversion systems and devices described above, it would be desirable to have power conversion systems and methods that provide increased versatility and functionality. Such power conversion systems and methods would be capable of minimizing ripple currents and satisfying transient power requirements, while providing high conversion efficiency. It would also be desirable to have power conversion systems and methods that can accommodate different power source and load voltages, while providing electrical isolation and increased protection against power system faults and transients.

### BRIEF SUMMARY OF THE INVENTION

In accordance with the present application, power converter systems and methods are provided that can combine multiple direct-current (DC) power sources with an independent alternating-current (AC) power source coupled across a load, thereby allowing power to be transferred between the DC power sources, the AC power source, and/or the load. The presently disclosed power converter systems and methods offer increased versatility and functionality over traditional power converter systems and devices.

In accordance with one aspect, a power converter system includes a first inverter having a first DC input and a first AC output, a second inverter having a second DC input and a second AC output, and a transformer having a primary side and a secondary side. At least one of the first and second inverters is implemented as a bidirectional inverter. In accordance with one exemplary aspect, the transformer has a first primary winding and a second primary winding on the primary side, and a secondary winding on the secondary side. The first DC input of the first inverter is coupleable to a first DC power source, and the second DC input of the second inverter is coupleable to a second DC power source. Further, the first AC output of the first inverter is coupled to the first primary winding of the transformer, and the second AC output of the second inverter is coupled to the second primary winding of the transformer. The secondary winding of the transformer is coupleable to the load. The first inverter is operative to convert a first DC power from the first DC power source into a first AC power, and to provide the first AC power to the first primary winding. The second inverter is operative to convert a second DC power from the second DC power source into a second AC power, and to provide the second AC power to the second primary winding. In accordance with another exemplary aspect, the first inverter is operative to convert a first DC current and a first DC voltage from the first DC power source into a first predetermined AC current and a first predetermined AC voltage, respectively, at the first primary winding. Further, the second inverter is operative to convert a second DC current and a second DC voltage from the second DC power source into a second predetermined AC current and a second predetermined AC voltage, respectively, at the second primary winding. Based on the relative magnitudes and phases of the first and second predetermined AC currents and/or the first and second predetermined AC voltages, the power converter system allows power to be transferred between some or all of the first DC power source, the second DC power source, and the load.

In accordance with still another exemplary aspect, the power converter system further includes a switch operative to switchably couple the independent AC power source across the load. While the switch is in an opened position, the AC power source is disconnected from the load, allowing power to be transferred between some or all of the first DC power source, the second DC power source, and the load based on the relative magnitudes and phases of the first and second predetermined AC currents and/or the first and second predetermined AC voltages. While the switch is in a closed position, the AC power source is connected across the load, allowing power to be transferred between some or all of the first DC power source, the second DC power source, the AC power source, and the load based on the relative magnitudes and phases of the first and second predetermined AC currents and/or the first and second predetermined AC voltages.

In accordance with one or more further exemplary aspects, the first inverter can be implemented as a first pulse width modulation (PWM) sine wave inverter, and the second inverter can be implemented as a second PWM sine wave inverter. Moreover, the power conversion system may be employed in conjunction with a programmable control signal source for controlling the characteristics of the AC currents and/or the AC voltages produced by the respective PWM inverters, thereby controlling the power flow between the first and second DC power sources, the AC power source, and the load. For example, the first DC power source can be implemented as a fuel cell or any other suitable DC power source, and the second DC power source can be implemented as a battery or any other suitable DC power source.

By implementing the first and second inverters in a single power converter stage between the first and second DC power sources and the load, the power conversion system can achieve high conversion efficiency. The respective AC outputs of the first and second inverters in the single power converter stage can also be employed alone or in combination to satisfy the transient power requirements of the load. In addition, by introducing suitable inverter-generated harmonic currents, ripple currents produced when the first and second DC power sources are used to supply a single phase AC load can be shared in a controlled fashion between the respective DC power sources. Moreover, different DC power source voltages and load voltages can be scaled by adjusting the turns ratios of the transformer. The transformer provides electrical isolation and protection against power system faults/transients, and prevents DC coupling between the first and second inverters and the AC power source, which can correspond to a 50/60 Hz electrical utility power grid. During such power system faults/transients, the AC power source can be disconnected from the load by placing the switch in the opened position, while allowing the first and second DC power sources to continue to provide AC power to the load. “Back-feeding” the respective DC power sources during system start-up can also be avoided by placing the switch in the opened position, obviating the need for DC power source disconnect switches.

Other features, functions, and aspects of the invention will be evident from the Drawings and/or the Detailed Description of the Invention that follow.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a block diagram of an exemplary power conversion system, according to an exemplary embodiment of the present application;

FIG. 2a is a block diagram of the exemplary power conversion system of FIG. 1, for use in describing a first illustrative example of the power conversion system of FIG. 1;

FIGS. 2b and 2c are diagrams of exemplary waveforms produced by the exemplary power conversion system of FIG. 2a, for use in describing the first illustrative example of FIG. 2a;

FIG. 3a is a block diagram of the exemplary power conversion system of FIG. 1, for use in describing a second illustrative example of the power conversion system of FIG. 1;

FIG. 3b is a diagram of exemplary waveforms produced by the exemplary power conversion system of FIG. 3a, for use in describing the second illustrative example of FIG. 3a;

FIG. 4a is a block diagram of the exemplary power conversion system of FIG. 1, for use in describing a third illustrative example of the power conversion system of FIG. 1;

FIG. 4b is a diagram of exemplary waveforms produced by the exemplary power conversion system of FIG. 4a, for use in describing the third illustrative example of FIG. 4a;

FIG. 5a is a block diagram of the exemplary power conversion system of FIG. 1, for use in describing a fourth illustrative example of the power conversion system of FIG. 1;

FIG. 5b is a diagram of exemplary waveforms produced by the exemplary power conversion system of FIG. 5a, for use in describing the fourth illustrative example of FIG. 5a;

FIG. 6 is a table listing possible power flows between two DC power sources and a load coupled to the power conversion system of FIG. 1;

FIG. 7 is a table listing possible power flows between the two DC power sources and the load coupled to the power conversion system of FIG. 1, and an AC power source coupled across the load;

FIG. 8 is a flow diagram of a method of operating the power conversion system of FIG. 1;

FIG. 9a is a schematic diagram of an exemplary inverter included in the power conversion system of FIG. 1; and

FIG. 9b are timing diagrams of exemplary control signals for controlling the inverter of FIG. 9a, and a diagram of an exemplary waveform produced by the inverter of FIG. 9a in response to the control signals.

### DETAILED DESCRIPTION OF THE INVENTION

Power converter systems and methods are provided that can combine multiple direct-current (DC) power sources with an independent alternating-current (AC) power source coupled across a load. The presently disclosed power converter systems and methods offer increased versatility and functionality over traditional power converter systems and devices.

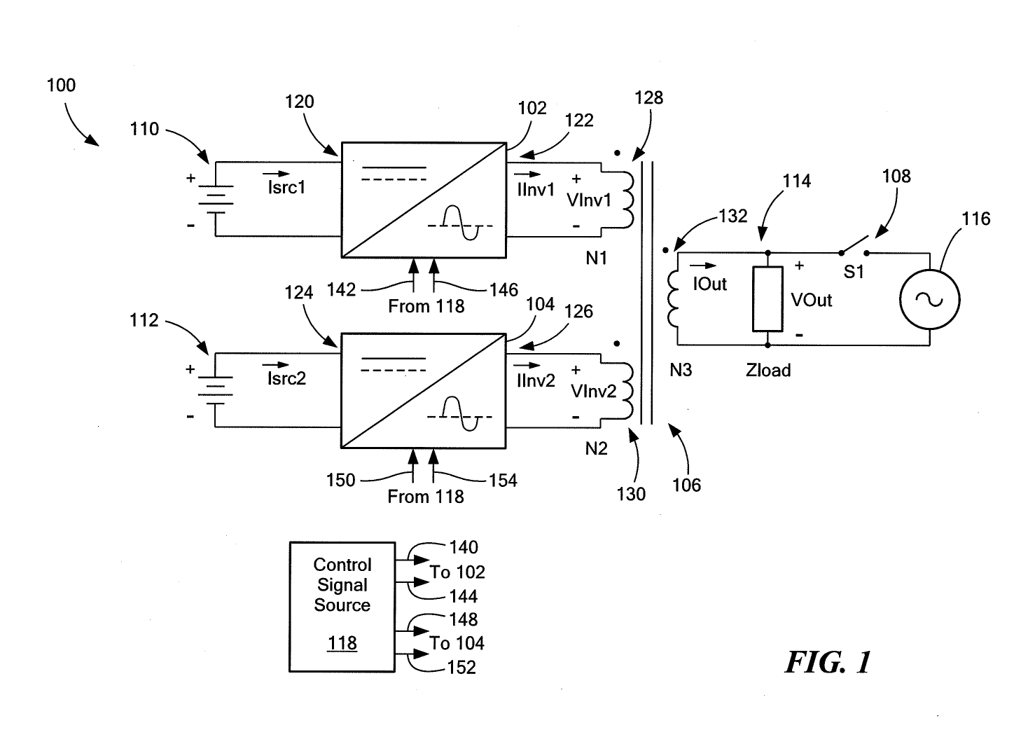

FIG. 1 depicts an illustrative embodiment of a power converter system 100, in accordance with the present application. The power converter system 100 includes a first inverter 102 having a first DC input 120 and a first AC output 122, a second inverter 104 having a second DC input 124 and a second AC output 126, and a transformer 106 having a primary side and a secondary side. As shown in FIG. 1, the transformer 106 has a first primary winding 128 and a second primary winding 130 on the primary side, and a secondary winding 132 on the secondary side. The first DC input 120 is coupleable to a first DC power source 110, and the second DC input 124 is coupleable to a second DC power source 112. Further, the first AC output 122 is coupled to the first primary winding 128, and the second AC output 126 is coupled to the second primary winding 130. The secondary winding 132 is coupleable to a load 114. The first inverter 102 is operative to convert a first DC power from the first DC power source 110 into a first AC power, and to provide the first AC power to the first primary winding 128. The second inverter 104 is operative to convert a second DC power from the second DC power source 112 into a second AC power, and to provide the second AC power to the second primary winding 130. More specifically, the first inverter 102 is operative to convert a first DC current and a first DC voltage from the first DC power source 110 into a first predetermined AC current and a first predetermined AC voltage, respectively, at the first primary winding 128. Further, the second inverter 104 is operative to convert a second DC current and a second DC voltage from the second DC power source 112 into a second predetermined AC current and a second predetermined AC voltage, respectively, at the second primary winding 130. Based on the relative magnitudes and phases of the first and second predetermined AC currents and/or the first and second predetermined AC voltages, the power converter system 100 allows power to be transferred between some or all of the first DC power source 110, the second DC power source 112, and the load 114.

As further shown in FIG. 1, the power converter system 100 also includes a switch 108 operative to switchably couple an AC power source 116 across the load 114. While the switch 108 is in an opened position, as depicted in FIG. 1, the AC power source 116 is disconnected from the load 114, allowing power to be transferred between some or all of the first DC power source 110, the second DC power source 112, and the load 114 based on the relative magnitudes and phases of the first and second predetermined AC currents and/or the first and second predetermined AC voltages. While the switch 108 is in a closed position, the AC power source 116 is connected across the load 114, allowing power to be transferred between some or all of the first DC power source 110, the second DC power source 112, the AC power source 116, and the load 114 based on the relative magnitudes and phases of the first and second predetermined AC currents and/or the first and second predetermined AC voltages.

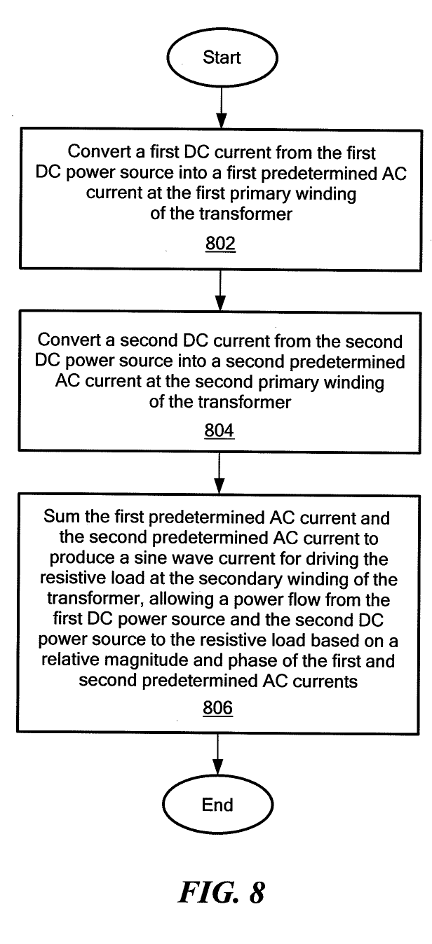

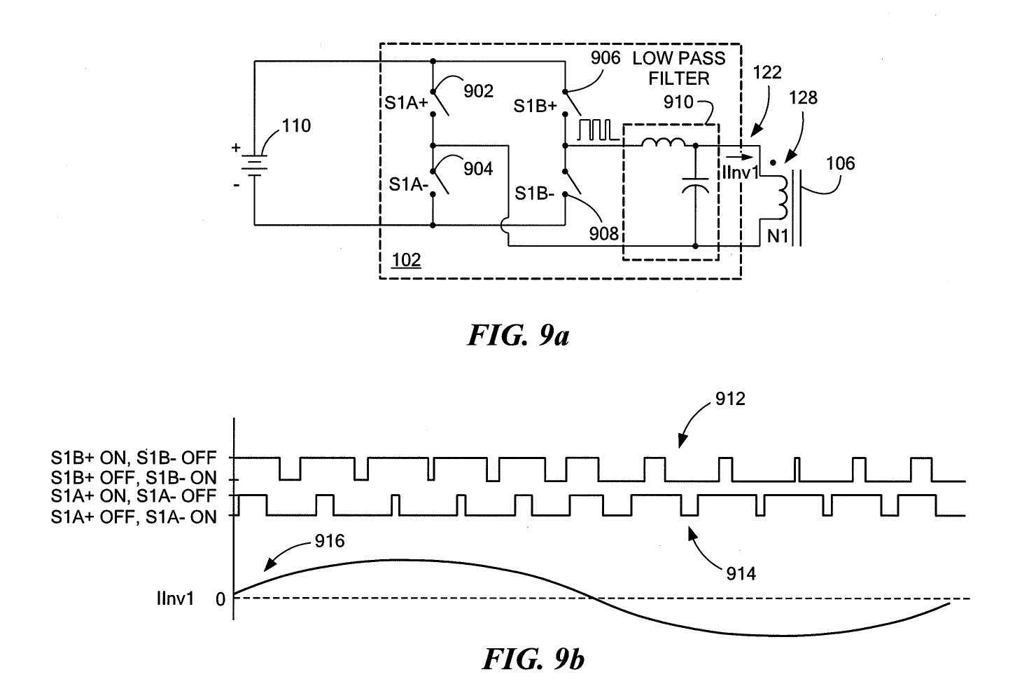

Each of the first and second inverters 102, 104 can be implemented as a respective pulse width modulation (PWM) sine wave inverter or any other suitable type of inverter. For example, FIG. 9a depicts an exemplary implementation of the first inverter 102, including a plurality of switches S1A+ 902, S1A− 904, S1B+ 906, and S1B− 908 and a low pass filter 910. It is noted that the second inverter 104 can be implemented like the first inverter 102. Further, the power conversion system 100 can be employed in conjunction with a programmable control signal source 118 (see FIG. 1) operative to control the first and second inverters 102, 104 for producing predetermined AC currents and/or predetermined AC voltages, thereby controlling the power flow between the first and second DC power sources 110, 112, the AC power source 116, and the load 114 based at least in part on the relative magnitudes and phases of the respective predetermined AC currents and/or AC voltages.

For example, FIG. 9b depicts an exemplary control signal 912 that may be produced by the control signal source 118 at an output 140 (see FIG. 1) and applied to the first inverter 102 at an input 142 (see FIG. 1), for controlling the operation of the exemplary switches S1B+ 906, S1B− 908 (see FIG. 9a) within the first inverter 102. FIG. 9b also depicts an exemplary control signal 914 that may be produced by the control signal source 118 at an output 144 (see FIG. 1) and applied to the first inverter 102 at an input 146 (see FIG. 1), for controlling the operation of the exemplary switches S1A+ 902, S1A− 904 within the first inverter 102. In addition, FIG. 9b depicts a desired AC current 916 that may be produced by the first inverter 102 at the first AC output 122 in response to the applied control signals 912, 914, thereby converting a DC current from the first DC power source 110 into the desired AC current 916 at the first primary winding 128. It is noted that suitable control signals may be produced by the control signal source 118 at outputs 148, 152 (see FIG. 1) and applied to the second inverter 104 at inputs 150, 154, respectively, for converting DC currents from the second DC power source 112 into desired AC currents at the second primary winding 130. In this way, the first and second inverters 102, 104 can be controlled to produce fundamental waveforms, harmonic waveforms, or any other desired AC signal waveforms from the DC power provided at the inputs of the respective inverters.

Moreover, the first DC power source 110 can be implemented as a fuel cell or any other suitable DC power source, and the second DC power source 112 can be implemented as a battery or any other suitable DC power source. Accordingly, in accordance with one or more alternative embodiments, the second inverter 104 can be implemented as a bidirectional inverter to allow charging of the battery, or both of the first and second inverters 102, 104 can be implemented as respective bidirectional inverters.

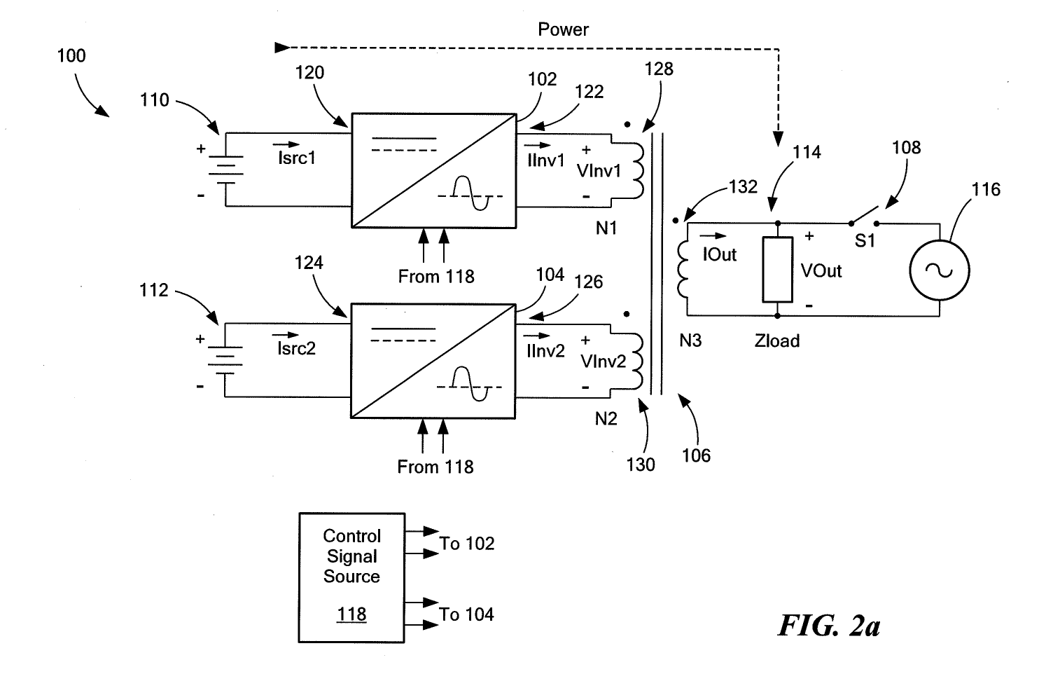

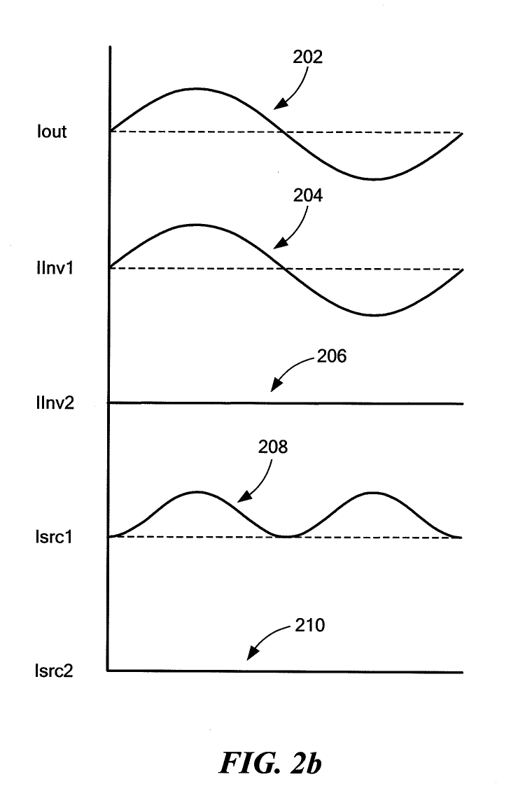

The presently disclosed power converter system 100 will be better understood with reference to the following illustrative examples and FIGS. 2a through 5b. In each of the illustrative examples described below, the first and second inverters 102, 104 are implemented as respective PWM inverters, the first DC power source 110 is implemented as a fuel cell, the second DC power source 112 is implemented as a battery, the load 114 is implemented as a resistive load, and the transformer 106 is assumed to be lossless. In addition, the number of turns N1 in the first primary winding, the number of turns N2 in the second primary winding, and the number of turns N3 in the secondary winding are all assumed to be equal. As a result, each of the exemplary current waveforms depicted in FIGS. 2b, 2c, 3b, 4b, and 5b have the same vertical and horizontal scale.

In accordance with a first illustrative example (see FIGS. 2a and 2b), the second DC power source 112 (i.e., the battery) is assumed to be inoperative, and the first DC power source 110 (i.e., the fuel cell) is employed as the primary or backup power source for the resistive load 114. The first inverter 102 converts a first DC current from the first DC power source 110 into a first predetermined AC current 204 (IInv1; see FIGS. 2a and 2b) at the first primary winding 128, and the second inverter 104 converts a second DC current from the second DC power source 112 into a second predetermined AC current 206 (IInv2; see FIGS. 2a and 2b) at the second primary winding 130. As shown in FIG. 2b, the second predetermined AC current 206 is equal to zero. The transformer 106 sums the first and second predetermined AC currents 204, 206, thereby producing a sine wave current 202 (Iout; see FIGS. 2a and 2b) for driving the resistive load 114. The resulting pulsing power at the resistive load 114 is reflected back through the power converter system 100 onto the first DC power source 110 as an AC current 208 (Isrc1; see FIGS. 2a and 2b), which is the product of the instantaneous sine wave current 202 (lout; see FIGS. 2a and 2b) and an instantaneous voltage Vout across the resistive load 114. It is noted that the corresponding AC current 210 (Isrc2; see FIGS. 2a and 2b) at the second DC power source 112 is equal to zero. As shown in FIG. 2a, with the switch 108 in the opened position, the power converter system 100 is operative to allow a (real) power flow (POWER; see FIG. 2a) from the first DC power source 110, through the first inverter 102 and the transformer 106, to the resistive load 114.

In accordance with a second illustrative example (see FIGS. 2a and 2c), the first inverter 102 converts a first DC current from the first DC power source 110 into a first predetermined AC current 224 (IInv1; see FIGS. 2a and 2c) at the first primary winding 128. Further, the second inverter 104 converts a second DC current from the second DC power source 112 into a second predetermined AC current 226 (IInv2; see FIGS. 2a and 2c) at the second primary winding 130, in which the second predetermined AC current 226 is made up of approximately 33% third harmonic and 5% fifth harmonic of the fundamental frequency required to fully power the resistive load 114. As shown in FIG. 2c, the first predetermined AC current 224 produced by the first inverter 102 is equal to the difference between a corresponding AC current at the fundamental frequency minus the second predetermined AC current 226. The transformer 106 sums the first and second predetermined AC currents 224, 226, thereby producing a sine wave current 222 (Iout; see FIGS. 2a and 2c) for driving the resistive load 114. The resulting pulsing power at the resistive load 114 is reflected back through the power converter system 100 onto the first DC power source 110 as an AC current 228 (Isrc1; see FIGS. 2a and 2c) and onto the second DC power source 112 as an AC current 230 (Isrc2; see FIGS. 2a and 2c). As shown in FIG. 2a, with the switch 108 in the opened position, the power converter system 100 is operative to allow a (real) power flow (POWER; see FIG. 2a) from the first DC power source 110, through the first inverter 102 and the transformer 106, to the resistive load 114. It is noted, however, that a reactive power may also flow in the second DC power source 112 (i.e., the battery). In effect, ripple currents produced by the first and second DC power sources 110, 112 are shared between the respective DC power sources 110, 112, thereby reducing the peak-to-peak excursions of the AC current 228. This may be beneficial if the first DC power source 110 is susceptible to damage from large current excursions, or if the source impedance of the first DC power source 110 limits the maximum power available to less than the peak power of the AC current 228.

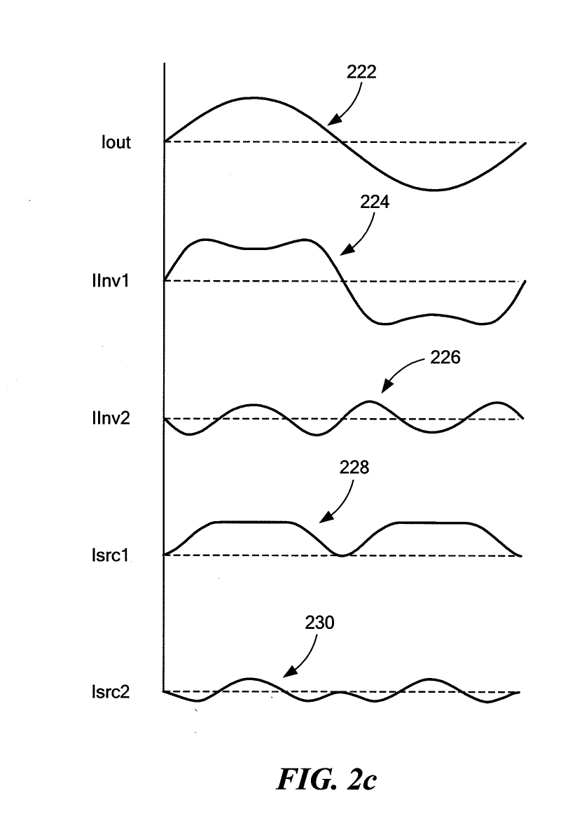

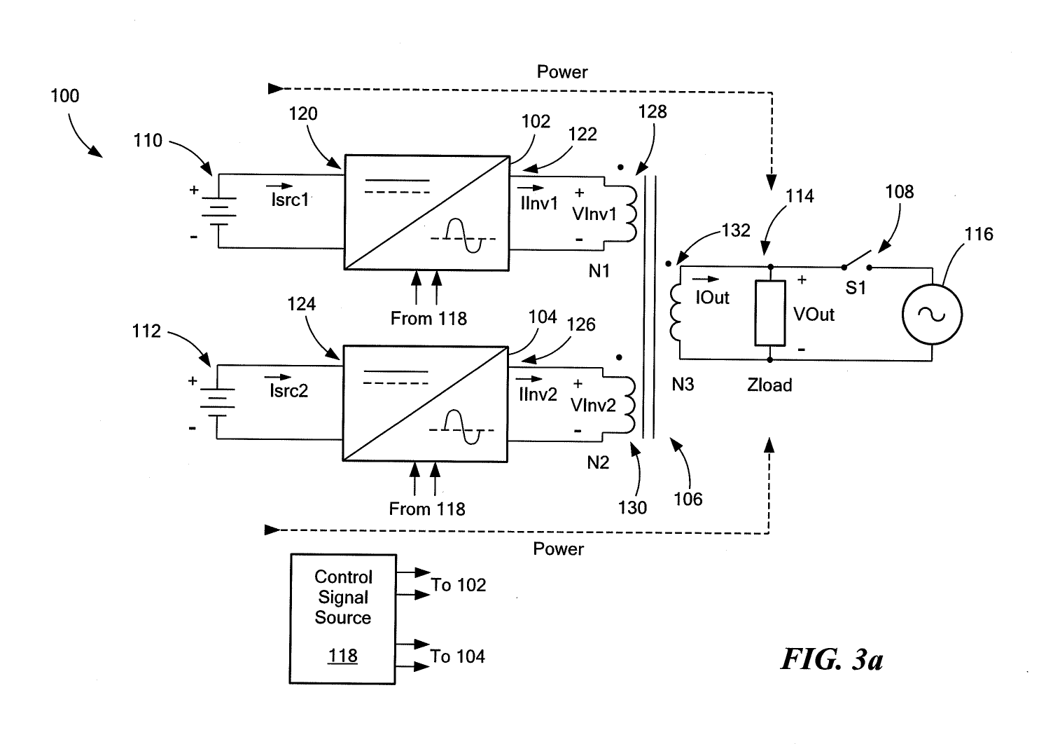

In accordance with a third illustrative example (see FIGS. 3a and 3b), the resistive load 114 is assumed to require a large transient surge of power, such as typically required when starting a motor. The first inverter 102 converts a first DC current from the first DC power source 110 into a first predetermined AC current 304 (IInv1; see FIGS. 3a and 3b) at the first primary winding 128, and the second inverter 104 converts a second DC current from the second DC power source 112 into a second predetermined AC current 306 (IInv2; see FIGS. 3a and 3b) at the second primary winding 130. The transformer 106 sums the first and second predetermined AC currents 304, 306, thereby producing a sine wave current 302 (Iout; see FIGS. 3a and 3b) for driving the resistive load 114. The resulting pulsing power at the resistive load 114 is reflected back through the power converter system 100 onto the first DC power source 110 as an AC current 308 (Isrc1; see FIGS. 3a and 3b), and onto the second DC power source 112 as an AC current 310 (Isrc2; see FIGS. 3a and 3b). As shown in FIG. 3a, with the switch 108 in the opened position, the power converter system 100 is operative to allow a (real) power flow (POWER; see FIG. 3a) from the first DC power source 110, through the first inverter 102 and the transformer 106, to the resistive load 114, and from the second DC power source 112, through the second inverter 104 and the transformer 106, to the resistive load 114.

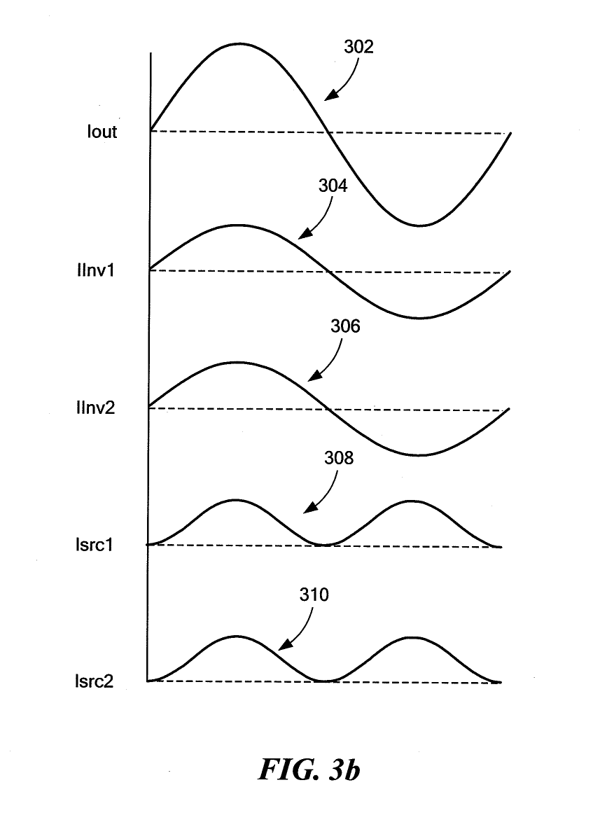

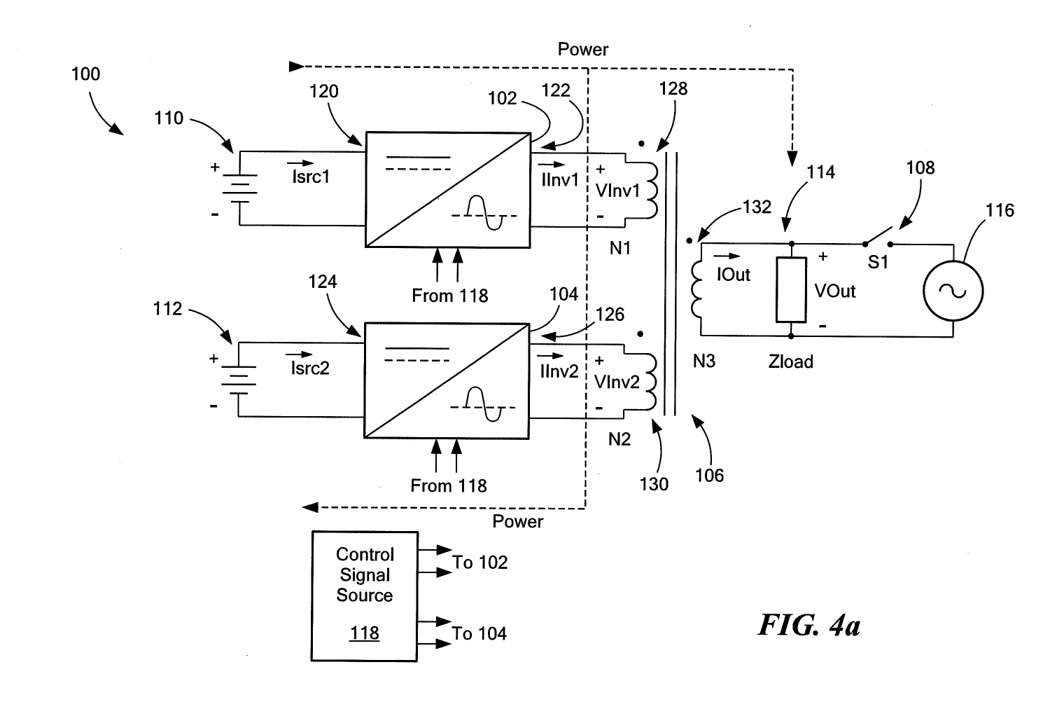

In accordance with a fourth illustrative example (see FIGS. 4a and 4b), it is assumed that a large load transient has discharged the second DC power source 112 (i.e., the battery). The first inverter 102 converts a first DC current from the first DC power source 110 into a first predetermined AC current 404 (IInv1; see FIGS. 4a and 4b) at the first primary winding 128, and the second inverter 104 converts a second DC current from the second DC power source 112 into a second predetermined AC current 406 (IInv2; see FIGS. 4a and 4b) at the second primary winding 130. The transformer 106 sums the first and second predetermined AC currents 404, 406, thereby producing a sine wave current 402 (Iout; see FIGS. 4a and 4b) for driving the resistive load 114. The resulting pulsing power at the resistive load 114 and the power delivered to charge the second DC power source 112 (i.e., the battery) is reflected back through the power converter system 100 onto the first DC power source 110 as an AC current 408 (Isrc1; see FIGS. 4a and 4b). In addition, the pulsing power absorbed by the second DC power source 112 (i.e., the battery) is reflected back onto the second DC power source 112 as an AC current 410 (Isrc2; see FIGS. 4a and 4b). As shown in FIG. 4a, with the switch 108 in the opened position, the power converter system 100 is operative to allow a (real) power flow (POWER; see FIG. 2a) from the first DC power source 110, through the first inverter 102 and the transformer 106, to the resistive load 114, and from the first DC power source 110, through the transformer 106, to the second DC power source 112 (i.e., the battery).

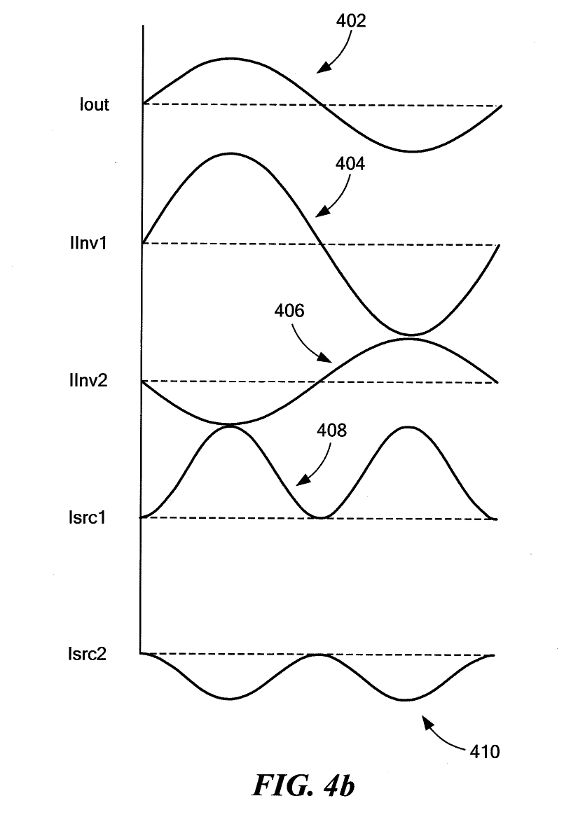

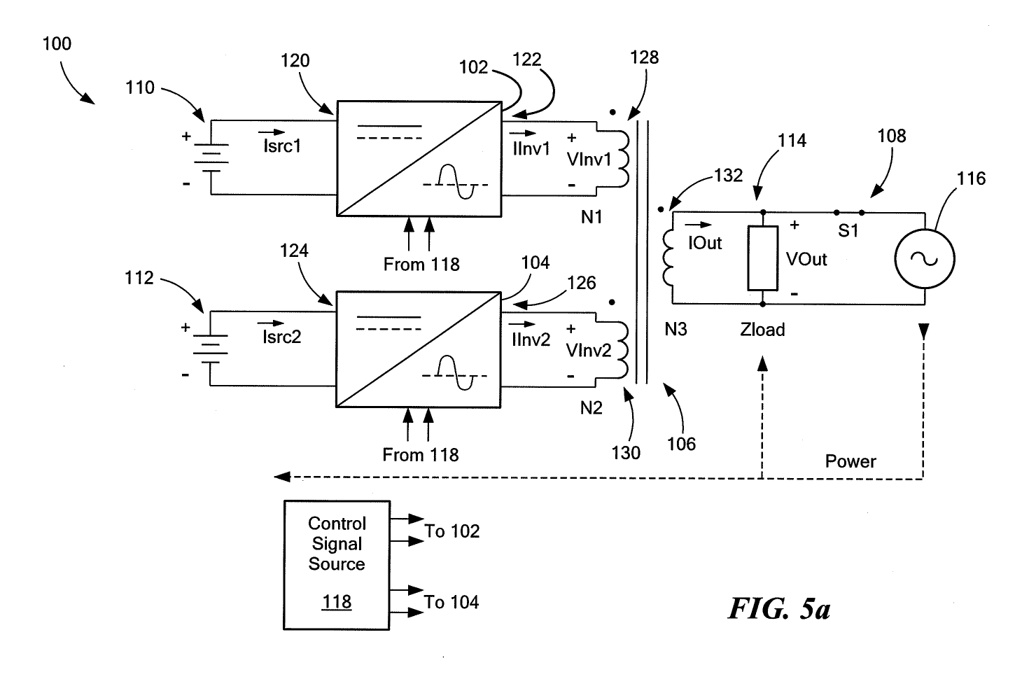

In accordance with a fifth illustrative example (see FIGS. 5a and 5b), the switch 108 is in the closed position, allowing a (real) power flow (POWER; see FIG. 5a) from the independent AC power source 116 to the resistive load 114, and from the independent AC power source 116 to the second DC power source 112 (i.e., the battery). For example, this fifth illustrative example may correspond to a power converter situation during startup of the first DC power source 110. The first inverter 102 converts a first DC current from the first DC power source 110 into a first predetermined AC current 504 (IInv1; see FIGS. 5a and 5b) at the first primary winding 128, and the second inverter 104 converts a second DC current from the second DC power source 112 into a second predetermined AC current 506 (IInv2; see FIGS. 5a and 5b) at the second primary winding 130. The transformer 106 sums the first and second predetermined AC currents 504, 506, thereby producing a sine wave current 502 (Iout; see FIGS. 5a and 5b) for driving the resistive load 114. The resulting pulsing power delivered to charge the second DC power source 112 (i.e., the battery) is reflected back through the power converter system 100 onto the second DC power source 112 as an AC current 510 (Isrc2; see FIGS. 5a and 5b). It is noted that the AC current 508 (Isrc1; see FIGS. 5a and 5c) at the first DC power source 110 is equal to zero. As shown in FIG. 5a, with the switch 108 in the closed position, the power converter system 100 is operative to allow a (real) power flow (POWER; see FIG. 2a) from the AC power source 116 to the resistive load 114, and from the independent AC power source 116, through the transformer 106 and the second inverter 104, to the second DC power source 112 (i.e., the battery).

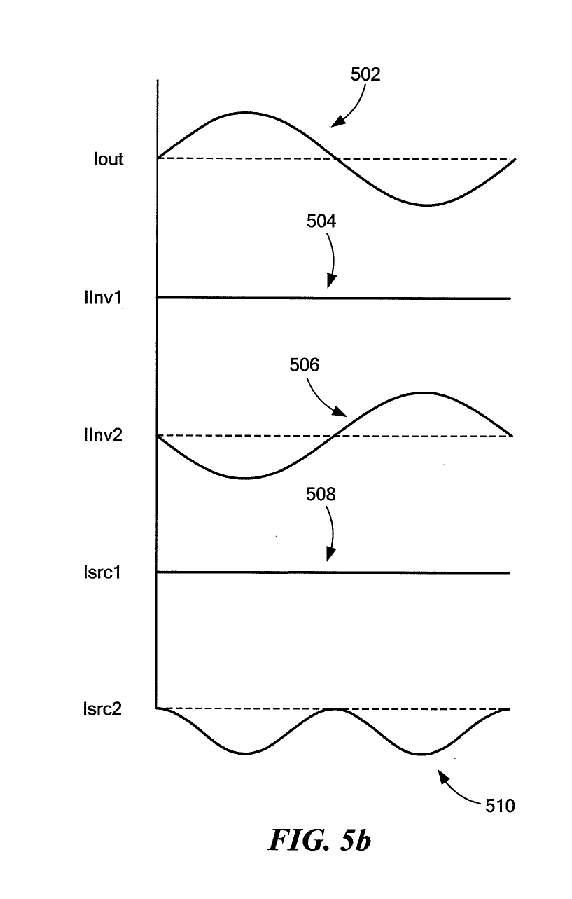

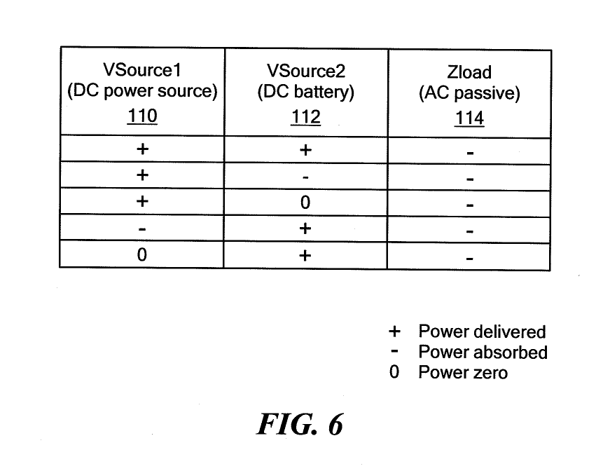

It is further noted that power flow paths other than those depicted in FIGS. 2a, 3a, 4a, and 5a are also possible within the power converter system 100 of FIG. 1. For example, FIG. 6 depicts a table listing the possible power flow paths within the power converter system 100 for the case in which the switch 108 is in the opened position, the first and second inverters 102, 104 are implemented as respective bidirectional inverters, and the first and second DC power sources 110, 112 and the AC power source 116 are each configured to allow bidirectional power flow. Further, FIG. 7 depicts a table listing the possible power flow paths within the power converter system 100 for the case in which the switch 108 is in the closed position, the first and second inverters 102, 104 are respective bidirectional inverters, and the first and second DC power sources 110, 112 and the AC power source 116 each allow bidirectional power flow. As described above, the power converter system 100 is operative to allow such power to be transferred between some or all of the first DC power source, the second DC power source, the AC power source, and the load based on the position of the switch 108 (opened or closed), and the relative magnitudes and phases of the AC currents and/or AC voltages produced at the respective AC outputs of the first and second inverters 102, 104.

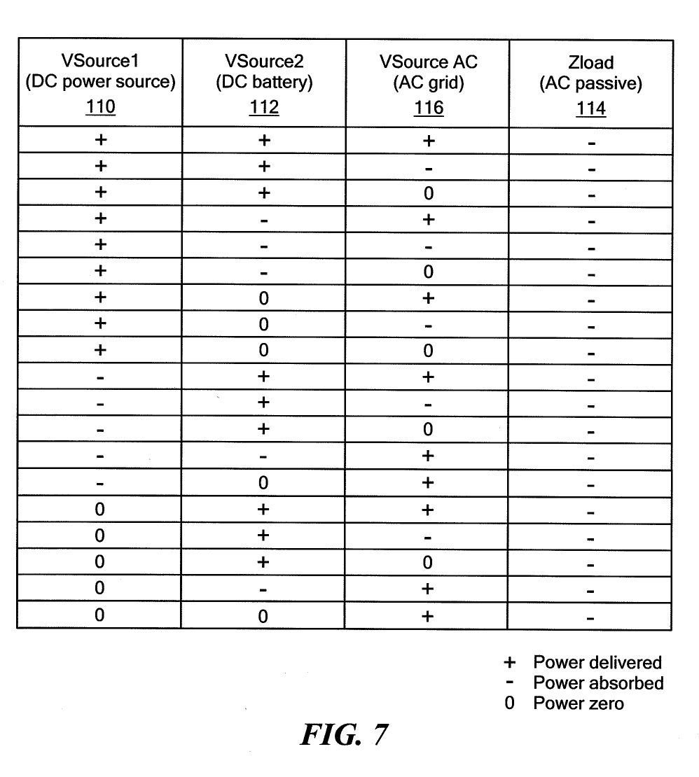

A method of operating the power conversion system 100 of FIG. 1 is described below with reference to FIGS. 1 and 8. As depicted in step 802, a first DC current from the first DC power source 110 is converted by the first inverter 102 into a first predetermined AC current at the first primary winding 128 of the transformer 106. As depicted in step 804, a second DC current from the second DC power source 112 is converted by the second inverter 104 into a second predetermined AC current at the second primary winding 130 of the transformer 106. As depicted in step 806, the first and second predetermined AC currents are summed by the transformer 106 to produce a sine wave current for driving the resistive load 114 at the secondary winding 132 of the transformer 106, thereby allowing a power flow from the first DC power source 110 and from the second DC power source 112 to the resistive load 114 based on a relative magnitude and phase of the first and second predetermined AC currents.

It will be appreciated by those skilled in the art that modifications to and variations of the above-described systems and methods may be made without departing from the inventive concepts disclosed herein. Accordingly, the invention should not be viewed as limited except as by the scope and spirit of the appended claims.

What is claimed is:

1. A power converter, comprising:
a transformer having a primary side, a secondary side, a first primary winding on the primary side, a second primary winding on the primary side, and a secondary winding on the secondary side, the secondary winding being coupleable to a load;
a first inverter having a first DC input coupleable to a first DC power source, and a first AC output coupled to the first primary winding, the first inverter being operative to convert a first DC current from the first DC power source into a first predetermined AC current at the first primary winding; and
a second inverter having a second DC input coupleable to a second DC power source, and a second AC output coupled to the second primary winding, the second inverter being operative to convert a second DC current from the second DC power source into a second predetermined AC current at the second primary winding,
wherein at least one of the first and second inverters is a bidirectional inverter, and
whereby power is allowed to be transferred between some or all of the first DC power source, the second DC power source, and the load based on a relative magnitude and phase of the first and second predetermined AC currents.

2. The power converter of claim 1 further including a switch operative to switchably couple an AC power source across the load, whereby power is allowed to be transferred between some or all of the first DC power source, the second DC power source, the AC power source, and the load based on the relative magnitude and phase of the first and second predetermined AC currents.

3. The power converter of claim 1 wherein the second inverter is further operative to convert the second DC current from the second DC power source into the second predetermined AC current at the second primary winding, the second predetermined AC current including at least one predetermined percentage of at least one predetermined harmonic of a fundamental frequency for fully powering the load.

4. The power converter of claim 3 wherein the first inverter is further operative to convert the first DC current from the first DC power source into the first predetermined AC current at the first primary winding, the first predetermined AC current being equal to an AC current at the fundamental frequency minus the second predetermined AC current.

5. The power converter of claim 1 wherein the first inverter comprises a first pulse width modulation (PWM) sine wave inverter, and wherein the second inverter comprises a second PWM sine wave inverter.

6. The power converter of claim 1 wherein the first DC input is coupleable to the first DC power source comprising a fuel cell, and wherein the second DC input is coupleable to the second DC power source comprising a battery.

7. A method of operating a power converter, comprising the steps of:
converting, by a first inverter, a first DC current from a first DC power source into a first predetermined AC current at a first primary winding of a transformer; and
converting, by a second inverter, a second DC current from a second DC power source into a second predetermined AC current at a second primary winding of the transformer, at least one of the first and second inverters being a bidirectional inverter, the transformer having a secondary winding coupleable to a load,
whereby power is allowed to be transferred between some or all of the first DC power source, the second DC power source, and the load based on a relative magnitude and phase of the first and second predetermined AC currents.

8. The method of claim 7 further including switchably coupling an AC power source across the load, whereby power is allowed to be transferred between some or all of the first DC power source, the second DC power source, the AC power source, and the load based on the relative magnitude and phase of the first and second predetermined AC currents.

9. The method of claim 7 wherein the step of converting the second DC current into the second predetermined AC current includes converting the second DC current into the second predetermined AC current including at least one predetermined percentage of at least one predetermined harmonic of a fundamental frequency for fully powering the load.

10. The method of claim 9 wherein the step of converting the first DC current into the first predetermined AC current includes converting the first DC current into the first predetermined AC current equal to an AC current at the fundamental frequency minus the second predetermined AC current.
